(19) United States
(12) Patent Application Publication
(10) Pub. No.: US 2011/0310140 A1
(43) Pub. Date: Dec. 22, 2011

(54) INKJET RECORDING APPARATUS AND TREATMENT LIQUID SUPPLY METHOD

(75) Inventors: Chie Tonohiro, Shizuoka-ken (JP); Takao Izumi, Kanagawa-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/112,052

(22) Filed: May 20, 2011

Related U.S. Application Data
(60) Provisional application No. 61/355,830, filed on Jun. 17, 2010.

(30) Foreign Application Priority Data
Mar. 24, 2011 (JP) P2011-065132

(51) Int. Cl. B41J 29/38

(52) U.S. Cl. 347/6

(57) ABSTRACT

This invention provides an inkjet recording apparatus which is provided with a supply unit which supplies a treatment liquid to a recording medium fed from a container and a recording unit which supplies ink to the recording medium with the treatment liquid supplied thereto and forms an image. In the inkjet recording apparatus, the treatment liquid with a first amount per unit area is supplied from the supply unit to a first region of the recording medium, and the treatment liquid with a second amount different from the first amount per unit area is supplied from the supply unit to a second region of the recording medium. The ink with the same amount per unit area is supplied from the recording unit to the first and second regions with the treatment liquid supplied thereto. States of the recording medium and the ink in the first and second regions with the ink supplied thereto are detected, and the supply of the treatment liquid to be supplied to the recording medium is regulated based on the detected states of the recording medium and the ink.

### CROSS-REFERENCE TO RELATED APPLICATION

The application is based upon and claims the benefit of priority from U.S. Provisional Application No. 61/355,830, filed Jun. 17, 2010; further this application is based upon and claims the benefit of priority from Japanese Patent Application No. P2011-65132, filed on Mar. 24, 2011; the entire contents of which are incorporated herein by references.

### FIELD

Embodiments of a present specification are generally related with an inkjet recording apparatus and a method of supplying a treatment liquid in an inkjet recording apparatus.

### BACKGROUND

Conventionally, in an inkjet recording type image forming apparatus, there has been known a method of supplying a treatment liquid to a recording medium before recording an image on the recording medium for the purposes of, for example, enhancement of printing quality, that is, fixing property, enhancement of the density, and prevention of blur. The treatment liquid and ink reliably react with each other to lead to enhancement of image quality, and therefore, there has been proposed that a method of supplying the treatment liquid to the recording medium is changed according to the kind of recording medium and image contents, or a method of reducing unevenness of the treatment liquid on the recording medium has been proposed.

However, the above methods are insufficient to supply a suitable amount of the treatment liquid according to the recording medium to be actually used in the image formation. If the suitable amount of the treatment liquid according to the recording medium is not supplied, image deterioration due to a shortage of the treatment liquid is induced, or an excess amount of the treatment liquid is supplied, so that the treatment liquid may be wasted.

### BRIEF DESCRIPTION OF THE DRAWINGS

FIG. 1 is a schematic configuration diagram of an inkjet recording apparatus.

FIG. 2 is a schematic configuration diagram of an image forming unit.

FIG. 3 is a block diagram showing a processing unit of the inkjet recording apparatus in a first embodiment.

FIG. 4 is a flow chart of regulation of the supply of a treatment liquid in the first embodiment.

FIG. 5 is an image diagram of an example of a treatment liquid supply regulation chart.

FIG. 6 is an image diagram of a modification of the treatment liquid supply regulation chart.

FIG. 7 is a schematic configuration diagram showing an inkjet recording apparatus according to an embodiment different from FIG. 1.

FIG. 8 is an image diagram of an example of the treatment liquid supply regulation chart where the inkjet recording apparatus of FIG. 7 is used.

FIG. 9 is a flow chart of the regulation of the supply of the treatment liquid in a second embodiment.

### DETAILED DESCRIPTION

A problem to be solved by embodiments to which the present invention is applied is to provide an inkjet recording apparatus which can supply an optimum amount of a treatment liquid to a recording medium to be used in the image formation.

An inkjet recording apparatus according to embodiments of the present invention is provided with a container which contains a recording medium therein, a supply unit which supplies a treatment liquid with a first amount per unit area to a first region of the recording medium fed from the container and supplies the treatment liquid with a second amount different from the first amount per unit area to a second region, a recording unit which supplies ink with the same amount per unit area to the first and second regions of the recording medium and forms an image, and a detection unit which detects states of the recording medium and the ink in the first and second regions to which the ink has been supplied.

The inkjet recording apparatus is further provided with a control unit which, based on the states of the recording medium and the ink detected by the detection unit, regulates the supply of the treatment liquid to be supplied to the recording medium.

Hereinafter, embodiments according to the present invention will be described with reference to the drawings.

### First Embodiment

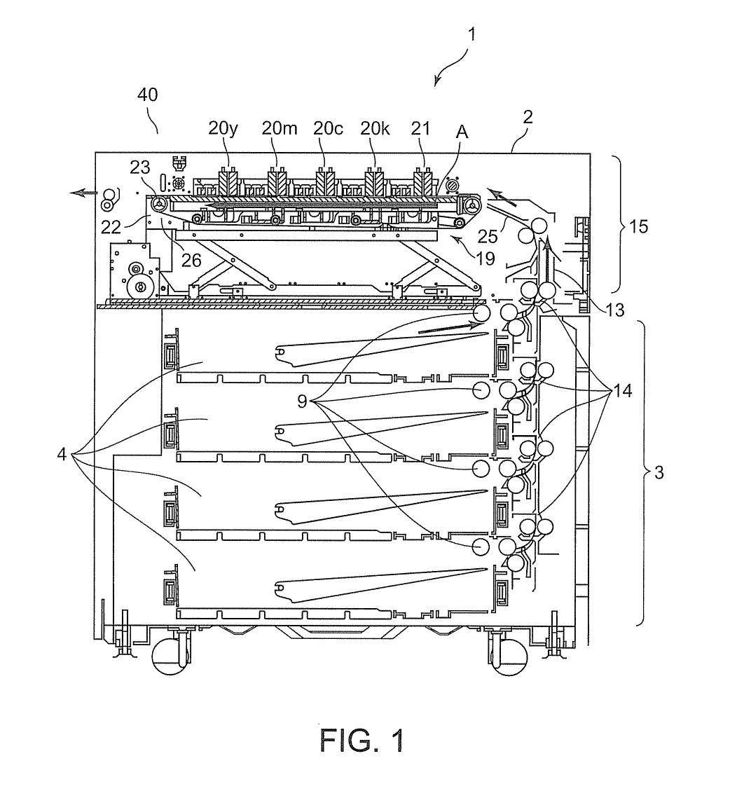

A first embodiment will be described with reference to FIGS. 1 to 7.

FIG. 1 is a schematic cross-sectional view showing an inkjet recording apparatus to which an embodiment of the present invention is applied. The inkjet recording apparatus ejects droplets onto a sheet S as a recording medium and can form characters and images on the sheet S.

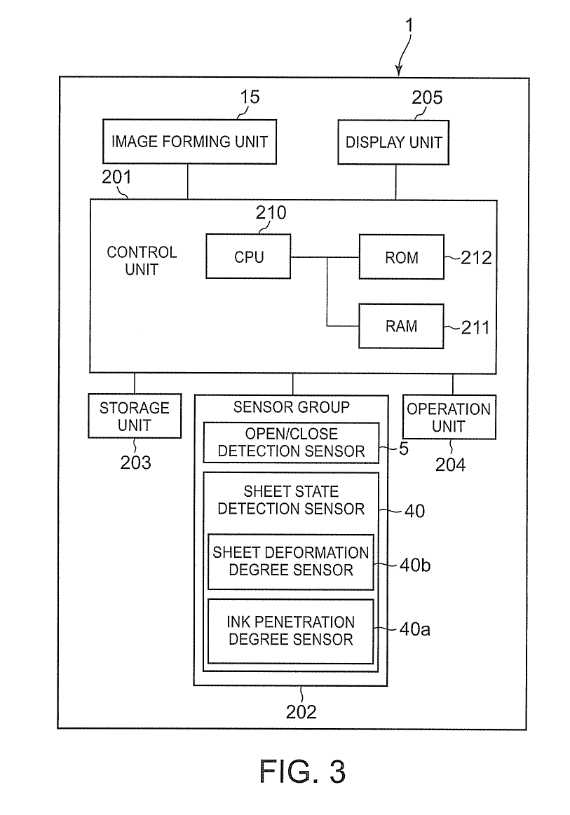

An inkjet recording apparatus 1 has a housing 2 which stores and arranges each component therein. The housing 2 has in its lower portion a container 3 which contains the sheets S as recording medium. The container 3 includes a plurality of sheet cassettes 4. The sheet cassettes 4 store therein the sheets S with different sizes, for example. Although described later, the sheet cassette 4 has an open/close detection sensor 5 (see, FIG. 3) as a detection unit which detects the opening and closing of the sheet cassette 4.

The sheet cassette 4 is provided with a pick-up roller 9. The sheets S stored in the sheet cassette 4 are picked up sheet by sheet by the pick-up roller 9 to be supplied to a feeding unit 13.

The feeding unit 13 has pairs of feed rollers 14 and feeds the sheet S supplied from the sheet cassette 4 by the rotation of the pairs of feed rollers 14 to an image forming unit 15. The arrows in FIG. 1 show a sheet feeding path.

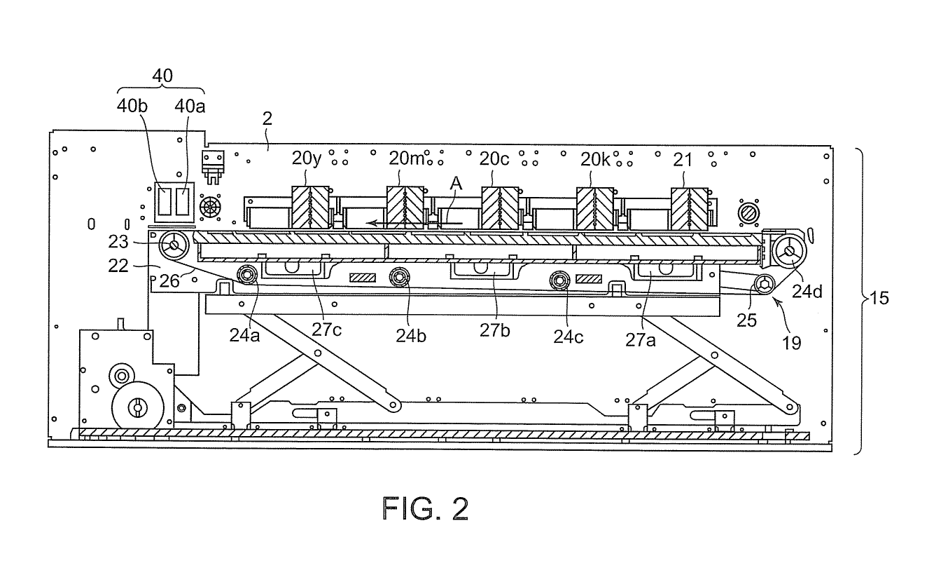

FIG. 2 is a schematic configuration diagram showing a constitution around the image forming unit 15. The image forming unit 15 records an image on the sheet S fed from the container 3 by the feeding unit 13. The image forming unit 15 includes a feeding mechanism 19, four inkjet heads 20k, 20c, 20m, and 20y as recording units, and a treatment liquid supply unit 21.

The feeding mechanism 19 feeds the sheet S, supplied from the feeding unit 13, below each of the inkjet heads 20k, 20c, 20m, and 20y at a constant speed in an arrow A direction. The feeding mechanism 19 has a feed housing 22. The feed housing 22 is provided with a drive roller 23 as a moving mechanism, follower rollers 24a, 24b, 24c, and 24d, and a tension roller 25. A feeding belt 26 is a continuous endless belt . The tension roller 25 applies a predetermined tension to the feeding belt 26. The drive roller 23 rotates to thereby move the feeding belt 26 to between the drive roller 23, the respective follower rollers 24a, 24b, 24c, and 24d, and the tension roller 25.

The respective inkjet heads 20k, 20c, 20m, and 20y are arranged at predetermined intervals in the feeding direction A of the feeding mechanism 19. The inkjet heads 20k, 20c, 20m, and 20y each have a plurality of ejection holes through which ink of each color such as black (K), cyan (C), magenta (N), or yellow (Y) is ejected. The inkjet heads 20k, 20c, 20m, and 20y eject the ink through the ejection holes, whereby the ink is supplied to the sheet S. Instead of the four inkjet heads 20k, 20c, 20m, and 20y, only at least one inkjet head may be provided, for example. For example, when only the inkjet head 20k is provided, a monochrome image is recorded on the sheet S.

The treatment liquid supply unit 21 is provided on the upstream side in the feeding direction A of the inkjet heads 20k, 20c, 20m, and 20y. The treatment liquid supply unit 21 ejects a treatment liquid by a head and supplies the treatment liquid to the sheet S. The treatment liquid accelerates the time of fixing the ink on the recording medium. The treatment liquid reacts with the ink on the recording medium to coagulate the ink, for example, and, thus, to keep coloration. The treatment liquid is a polymer solution such as carboxymethylcellulose, polyvinyl alcohol, and polyvinyl acetate.

The ink is ejected from the inkjet heads 20k, 20c, 20m, and 20y onto the sheet S to which the treatment liquid has been supplied by the treatment liquid supply unit 21, so that an image is recorded on the sheet S. A sheet state detection sensor 40 as a detection unit which detects the state of the sheet S with an image formed thereon is arranged on the downstream side of the inkjet heads 20k, 20c, 20m, and 20y. In the present embodiment, the sheet state detection sensor 40 includes a sheet deformation degree sensor 40b and an ink penetration degree sensor 40a. The sheet state detection sensor 40 is used in the after-described regulation of the supply of the treatment liquid to be supplied to the sheet S.

According to the above constitution, after the image is recorded on the sheet S, the sheet S is discharged outside of the housing 2 by a discharge unit 28. Although a specific example is not illustrated, the inkjet recording apparatus 1 has a display unit 205 which performs notification to a user and an operation unit 204 through which the user requests printing and performs print setting (see, FIG. 3). The display unit 205 and the operation unit 204 will be described later.

FIG. 3 is a block diagram showing a processing unit which performs various controls of the inkjet recording apparatus 1 in the present embodiment.

The inkjet recording apparatus 1 includes a control unit 201, the image forming unit 15, a sensor group 202, a storage unit 203, the operation unit 204, and the display unit 205.

The control unit 201 is provided with a CPU (Central Processing Unit) 210, a RAM (Random Access Memory) 211, and a ROM (Read Only Memory) 212. The CPU 210 is a processor which takes charge of the control to be executed by the control unit 201. The RAM 211 is a memory which temporarily stores working data therein and stores reference data therein. The ROM 212 is a non-volatile memory and stores therein a control program and control data for controlling the inkjet recording apparatus 1. The CPU 210 realizes various processings and various functions by operating based on the control program stored in the ROM 212. Although the CPU 210 is used as a processor, the kind of processors is not limited thereto.

The storage unit 203 is a writable memory. When the amount of a pretreatment liquid to be supplied to the sheet S is regulated, the storage unit 203 can store an optimum supply of the treatment liquid to be supplied to the sheet S according to the regulation result.

The sensor group 202 includes various sensors in the inkjet recording apparatus. The sensor group 202 includes the open/close detection 5 of the sheet cassette 4 described above and the sheet deformation degree sensor 40b and the ink penetration degree sensor 40a constituting the sheet state detection sensor 40 which detects the state of the printed sheet S with the treatment liquid supplied thereto when the supply of the treatment liquid to be supplied to the sheet S are regulated.

The operation unit 204 includes various operation keys and a keyboard. Auser inputs print setting or instructs printing through the operation unit 204. For example, an LCD (Liquid Crystal Display) is used as the display unit 205, and a notification to the user is displayed on the LCD. Alternatively, a display device with a built-in touch panel is used, and the display device may serve as the operation unit 204 and the display unit 205. Accordingly, an input unit includes both the operation unit 204 and the display unit 205.

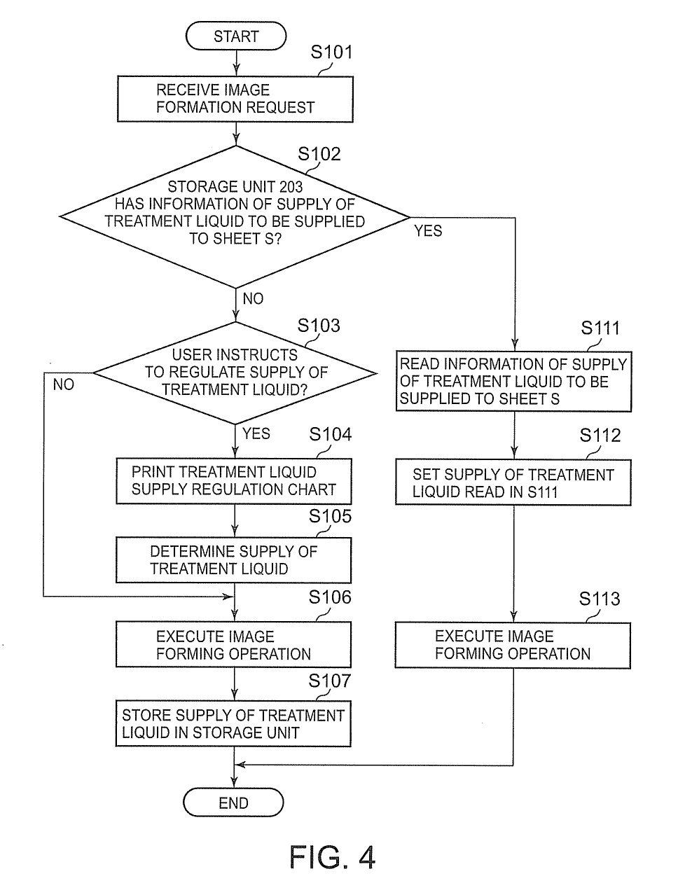

Next, the regulation of the supply of the treatment liquid to be supplied to the sheet S will be described. FIG. 4 is a flow chart for the regulation of the supply of the treatment liquid in the present embodiment.

When an image formation request including information of the sheet used in the image formation is received by a user's input through the operation unit 204 (S101), the control unit 201 judges whether information of a relationship between the sheet used in the image formation and the supply of the treatment liquid is stored in the storage unit 203 (S102).

When the control unit 201 judges that the information of the supply of the treatment liquid to be supplied to the sheet S used in the image formation is stored in the storage unit 203 (YES in step S102), the information is read from the storage unit 203 (S111) . Thereafter, the control unit 201 sets the supply of the treatment liquid that has been read from the storage unit 203 (S112) and executes the image forming operation based on the image formation request from the user (S113). The image forming job is terminated thus.

When the control unit 201 judges that the information of the supply of the treatment liquid to be supplied to the sheet S used in the image formation is not stored in the storage unit 203 (No in step S102), the control unit 201 urges, through the display unit 205, the user to input whether the supply of the treatment liquid is regulated, and the control unit 201 judges whether the user instructs to regulate the supply of the treatment liquid through the operation unit 204 (S103).

When the control unit 201 judges that the user instructs to regulate the supply of the treatment liquid (YES in step S103), the single sheet S is fed from the sheet cassette 4, and a treatment liquid supply regulation chart is printed on the fed sheet S (S104).

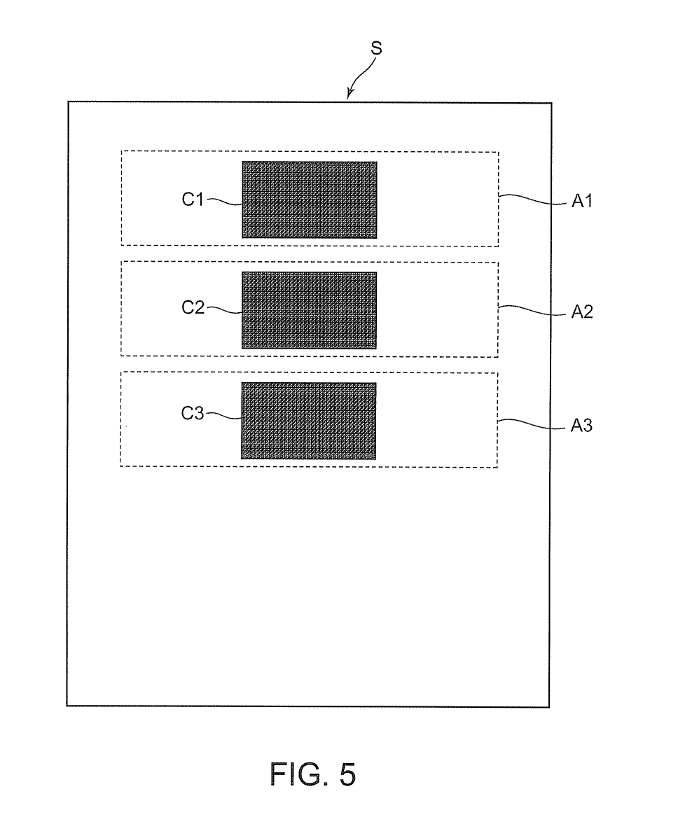

The treatment liquid supply regulation chart will be described in detail. FIG. 5 is an example of an image diagram of the treatment liquid supply regulation chart. The treatment liquid supply unit 21 supplies the treatment liquid to the sheet S fed from the sheet cassette 4. The areas of regions Al to A3 (regions to which the treatment liquid is supplied) of the sheet S shown in FIG. 5 are equal to each other . The treatment liquids with different amounts are ejected to the regions A1 to A3. The treatment liquid with an amount b1 is supplied to the region A1. The treatment liquid with an amount b2 is supplied to the region A2. The treatment liquid with an amount b3 is supplied to the region A3. The treatment liquids with different amounts are supplied to the regions A1 to A3 having the same area thus, whereby the supply per unit area of each of the regions A1 to A3 is changed. The relationship between the amounts b1 to b3 of the treatment liquids is b1>b2>b3, for example.

After the treatment liquid is supplied to the sheet S, the ink is ejected from the inkjet head to each of the regions A1 to A3 under the same conditions, e.g. with the same ink amount per unit area, so that an image is formed. At that time, as shown by C1 to C3 of FIG. 5, for example, the inkjet head 20K of black (K) ejects the maximum amount of ink that can be ejected to the regions A1 to A3 with the same area, whereby black solid printing is performed. With regard to the supply of the ink and the area, the supply areas are not necessarily the same as long as the ink with the same amount per unit area is supplied.

In the above embodiment, although the black (K) solid printing is performed, printing using any one of YMC, a combination of a plurality of colors, or all colors may be performed. Not solid printing requiring the maximum ink amount but printing with the ink amount of less than 100% maybe performed

As described above, the treatment liquids with different amounts b1 to b3 (b1>b2>b3) are supplied respectively to the different regions A1 to A3 in the single sheet, and the ink with the same amount is ejected onto the regions A1 to A3 with the same area. The relevant sheet is used as the treatment liquid supply regulation chart. In the image diagram of FIG. 5, although the amount of the treatment liquid is changed in only three stages, the number of stages of the treatment liquid amount is not limited to three, and the treatment liquid amount may be changed in a larger number of stages to create the supply regulation chart.

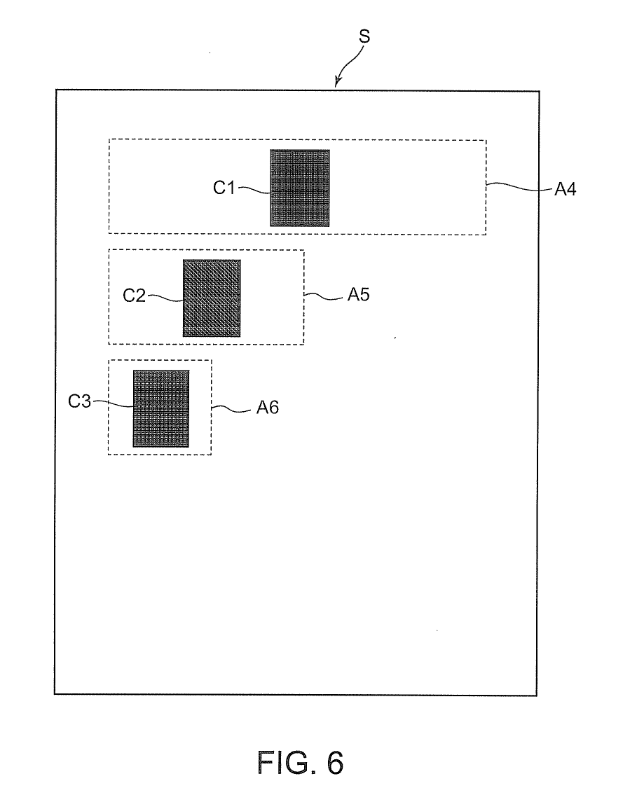

FIG. 6 shows a modification of the treatment liquid supply regulation chart. In the supply regulation chart of FIG. 6, the treatment liquids with the same amount are supplied to regions A4 to A6 with different areas (A4>A5>A6), and the supply of the treatment liquid per unit area in each of the regions A4 to A6 is changed. According to such an embodiment, in comparison with the case of creating the regulation chart of FIG. 5, the treatment liquid supply area can be reduced, and the area to be reduced is regulated, whereby the amount of the treatment liquid to be used can be reduced. After the supply of the treatment liquid, the ink with the same amount is supplied on the treatment liquid with the same area as in the case of creating the supply regulation chart of FIG. 5.

Returning to FIG. 4, the treatment liquid supply regulation chart is printed on the single sheet S fed from the sheet cassette 4 (S104), and thereafter, the control unit 201 determines the optimum supply of the treatment liquid based on the supply regulation chart (S105). The method of determining the optimum supply of the treatment liquid to be supplied to the sheet S will be described in detail.

After the creation of the treatment liquid supply regulation chart, the state of the sheet is detected using the sheet state detection sensor 40 arranged downstream of the inkjet heads 20k, 20c, 20m, and 20y. In the present embodiment, a sheet deformation degree and an ink penetration degree are examined as the state of the sheet S in each of the regions A1 to A3. In the examination of the sheet deformation degree, the time until when reflected light is detected when light is applied to the surface of the sheet S is measured using the sheet deformation degree sensor 40b which is an optical sensor, whereby the magnitude of undulation of the sheet (amount of irregularities) is examined. In the examination of the ink penetration degree, light is applied to the surface of the sheet S using the ink penetration degree sensor 40a which is an optical sensor, and the density of the ink is measured by the amount of detected reflected light, whereby the ink penetration degree is evaluated.

When the sheet deformation degree is large, an excess amount of the treatment liquid is supplied, and the deformation of the sheet S may be induced; therefore, the supply of the treatment liquid is required to be reduced. When the ink penetration degree is high, the amount of the treatment liquid is insufficient, so that the ink is not accumulated on the surface of the sheet S, and the ink may penetrate into the sheet S. Therefore, the supply of the treatment liquid is required to be increased. Thus, the optimum amount of the treatment liquid to be supplied to the sheet S is determined by a balance between the sheet deformation degree and the ink penetration degree.

The RAM 211 of the control unit 201 stores therein data of an optimum relationship between the sheet deformation degree and the ink penetration degree. The control unit 201 refers the data of the relationship between the sheet deformation degree and the ink penetration degree that is stored in the RAM 211 and judges the region where the sheet deformation degree and the ink penetration degree have an optimum relationship among the regions A1 to A3 in the supply regulation chart, whereby the optimum supply of the treatment liquid to be supplied to the sheet S is determined.

Returning to FIG. 4, when the optimum supply of the treatment liquid is determined (S105), the image forming operation is executed using the determined treatment liquid supply (S106). According to the above operation, the image forming operation based on the image formation request from the user is terminated.

In step S103, when the control unit 201 judges that the user does not instruct to regulate the supply of the treatment liquid (No in step S103), the image forming operation is executed in accordance with a previously set supply of the treatment liquid (S106).

Thereafter, the regulated supply of the treatment liquid to be supplied to the sheet S is stored in the storage unit 203 (S107), and the image forming job is terminated.

Next, the case where the information of the supply of the treatment liquid to be supplied to the sheet S that is stored in the storage unit 203 is deleted will be described. The supply of the treatment liquid to be supplied to the sheet S is regulated, and the information thereof is stored in the storage unit 203. Thereafter, when the sheet S stored in the sheet cassette 4 may be exchanged, the information of the supply of the treatment liquid to be supplied to the sheet S that is stored in the storage unit 203 is required to be deleted.

Namely, when the open/close detection sensor 5 of the sheet cassette 4 detects that the sheet cassette 4 is opened, or when the open/close detection sensor 5 is shifted from an unworking state to a workable state, the information of the supply of the treatment liquid to be supplied to the sheet S is deleted from the storage unit 203. The case where “the state of the open/close detection sensor 5 is shifted from the unworking state to the workable state” namely means a case where the open/close detection sensor 5 is shifted from a non power supplied state to a power supplied state.

The power is not supplied to the open/close detection sensor 5, and when the open/close detection sensor 5 is in the nonworking state, even if the sheet cassette 4 is opened, the sensor cannot detect that. When the open/close detection sensor 5 is in the nonworking state, the sheets S in the sheet cassette 4 may be exchanged. When the open/close detection sensor 5 is unworking, it is considered that a power supply of the inkjet recording apparatus 1 itself is turned off, or that the inkjet recording apparatus 1 is in a power saving mode, for example, so that the power is not supplied to the open/close detection sensor 5. Accordingly, when the open/close detection sensor 5 is shifted from the unworking state to the workable state, in consideration of the above possibility, the information of the supply of the treatment liquid to be supplied to the sheet S that is stored in the storage unit 203 is automatically deleted.

According to the above embodiment, the treatment liquids with various amounts are actually supplied to the recording medium to be used in the image formation, an image is formed on the recording medium, and the state of the recording medium is detected, whereby the amount of the treatment liquid that is most suitable for printing of the recording medium to be used in the image formation can be discriminated. If the most suitable amount of the treatment liquid can be supplied to each recording medium, the image quality can be improved.

The supply of the treatment liquid is regulated after the user's intention is confirmed, whereby when a user does not want to use the sheet in the supply regulation, or when the number of prints is small, if a user does not require to regulate the supply of the treatment liquid, the supply of the treatment liquid is not regulated, and therefore, the user's intention is reflected.

In the above embodiment, when the information of the supply of the treatment liquid to be supplied to the sheet S is stored in the storage unit 203, the supply of the treatment liquid to be supplied to the sheet S is not regulated. However, when the information of the supply of the treatment liquid to be supplied to the sheet S is stored in the storage unit 203, if a user requests to regulate the supply of the treatment liquid through the operation unit 204, the supply of the treatment liquid may be regulated.

In the above embodiment, the inkjet recording apparatus 1 has the operation unit 204 and the display unit 205, and a user instructs printing through the operation unit 204, and notification is performed to the user through the display unit 205. However, the inkjet recording apparatus 1 is connected to an external apparatus, and the user instructs image formation through the external apparatus, and notification maybe performed to the user through the external apparatus. The external apparatus includes a PC (Personal Computer).

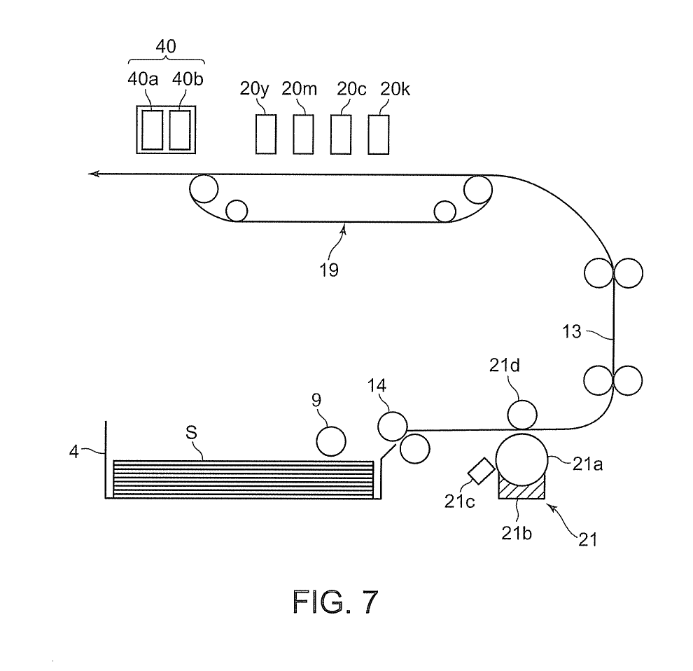

Next, another embodiment of the inkjet recording apparatus 1 will be described. FIG. 7 is a cross-sectional view showing a schematic configuration of a modification of the inkjet recording apparatus 1. The inkjet recording apparatus 1 shown in FIG. 7 is different from the inkjet recording apparatus 1 described above in the method of supplying the treatment liquid to the sheet S.

In the modification of FIG. 7, the treatment liquid is supplied to the sheet S by using a roller instead of a head. A treatment liquid supply unit 21 is arranged upstream of inkjet heads 20k, 20c, 20m, and 20y in the feeding direction of the sheet S and supplies the treatment liquid to the sheet S. The treatment liquid supply unit 21 is provided with a roller 21a which supplies the treatment liquid to the sheet S, a storage tank 21b which stores the treatment liquid therein, and an auxiliary roller 21d arranged at a position facing a treatment liquid regulation blade 21c and the roller 21a.

The roller 21a is arranged so that a unit of the roller 21a is in contact with the treatment liquid stored in the storage tank 21b. The roller 21a is arranged thus, whereby the treatment liquid is supplied to the surface of the roller 21a. After the treatment liquid is supplied from the storage tank 21b to the surface of the roller 21a, the amount of the treatment liquid adhered onto the roller 21a is regulated by the regulation blade 21c. The amount of the treatment liquid on the roller 21a is regulated by the regulation blade 21c thus, whereby the amount of the treatment liquid to be supplied to the sheet S can be changed.

After the treatment liquid is supplied to the surface of the roller 21a, when the sheet S is fed into between the roller 21a and the auxiliary roller 21d, the treatment liquid is supplied from the roller 21a to the sheet S. The operation after the supply of the treatment liquid to the sheet S is similar to the operation of the inkjet recording apparatus 1 of FIG. 1.

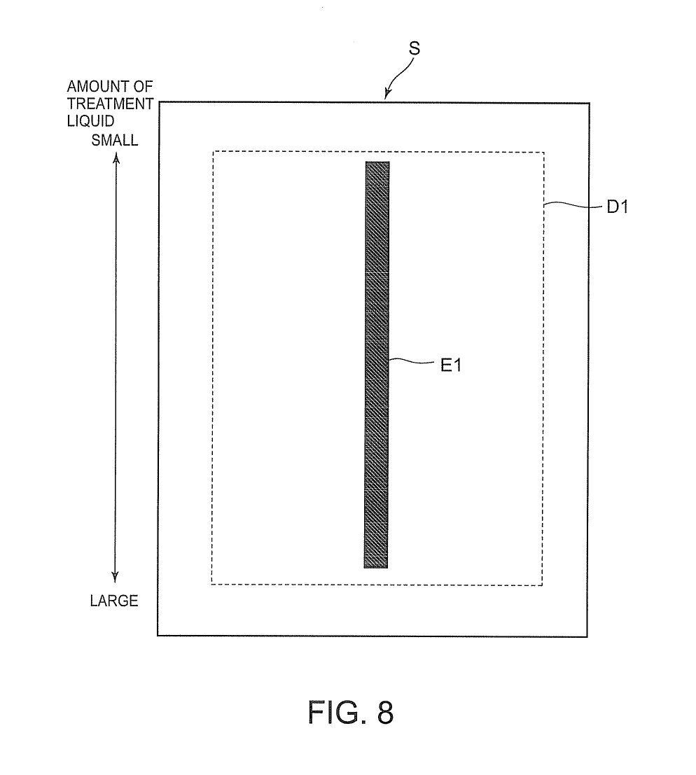

Next, the treatment liquid supply regulation chart will be described. FIG. 8 shows an image diagram of the treatment liquid supply regulation chart where the treatment liquid is supplied using the roller 21a. In the supply regulation chart of FIG. 8, the treatment liquid is supplied to a portion D1 of the sheet S so that the amount of the treatment liquid is gradually changed from small to large in a gradation manner. When the roller 21a is used, unlike the case where the treatment liquid ejected from ahead is supplied to the sheet S, it is difficult , to clearly switch the supply of the treatment liquid so that the treatment liquids with different amounts are supplied to the regions A1 to A3 of the sheet S. Therefore, the treatment liquid is supplied to the portion D1 so that the amount of the treatment liquid is gradually changed. Also when the amount of the treatment liquid is changed in a gradation manner thus, it can be said that the supply of the treatment liquid per unit area is different in different regions in a region to which the treatment liquid has been supplied.

After the treatment liquid is supplied to the portion D1 so that the amount of the treatment liquid is gradually changed, solid printing as shown by E1 is performed. As in the above case where the treatment liquid is supplied from the head, the optimum amount of the treatment liquid to be supplied to the sheet S is determined from the supply regulation chart created thus.

In the above embodiment, although measurement is performed with the maximum amount of black (K) ink, the solid printing requiring the maximum ink amount may not be performed.

### Second Embodiment

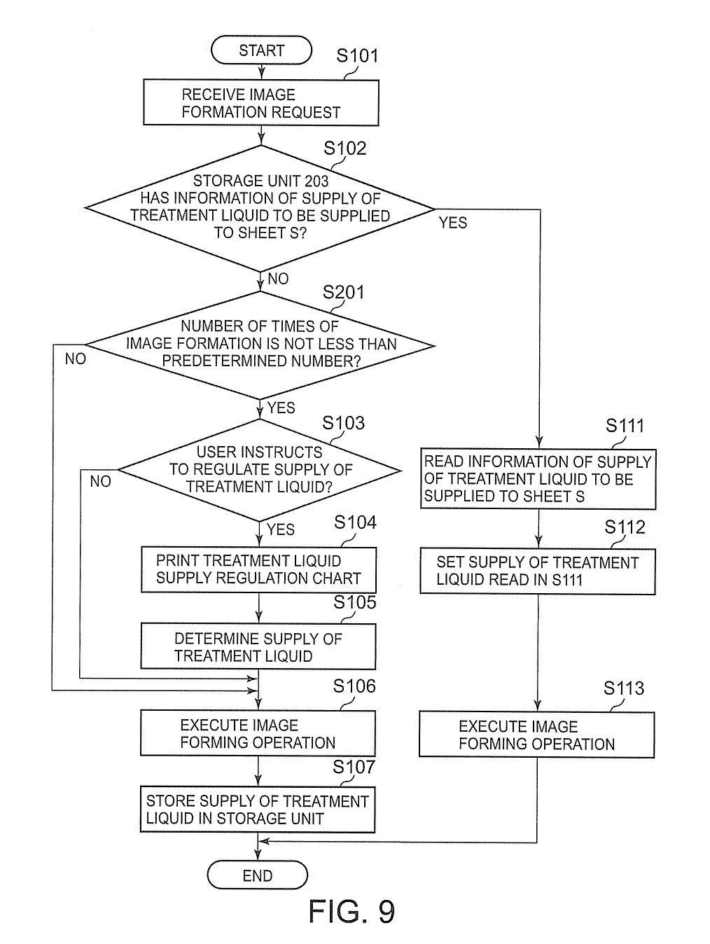

A second embodiment will be described with reference to FIG. 9.

Hereinafter, the same components as those of the above embodiment are assigned the same reference numerals, and only the features of the present embodiment will be described. In the present embodiment, when the number of prints does not reach a predetermined number, such setting can be performed that the supply of the treatment liquid to be supplied to the sheet S is not regulated.

FIG. 9 is a flow chart for the regulation of the supply of the treatment liquid in the present embodiment. The same operations as those of the flow chart of FIG. 4 of the first embodiment are assigned the same numbers, and the description will not be repeated.

In step S102, a control unit 201 judges that the information of the relationship between the sheet S used in the image formation and the supply of the treatment liquid is not stored in the storage unit 203 (NO in step S102), the control unit 201 then judges whether the number of times of image formation in the image formation request received from a user is not less than a predetermined number (S201).

In step S201, when the control unit 201 judges that the number of times of image formation is not less than the predetermined number (YES in step S201), the processing proceeds to step S103, and the operation similar to that in the flow chart of FIG. 4 of the first embodiment is performed.

In step S201, when the control unit 201 judges that the number of times of image formation does not reach the predetermined number (NO in step S201), the image forming operation is executed in accordance with a previously set supply of the treatment liquid (S106).

According to the above embodiment, when the number of times of image formation is less than the predetermined number, the sheet S and the supply of the treatment liquid are not regulated. When the number of times of image formation is small, it is highly likely that a user does not want to regulate the treatment liquid to the sheet S with the use of one sheet. Thus, it is effective to enable a control of regulating the supply of the treatment liquid to be supplied to the sheet S only when the number of times of image formation is not less than the predetermined number.

The predetermined number may be set by a user through the operation unit 204. When the user can set the predetermined number, the user's intention can be further reflected, and therefore, the convenience for users is enhanced.

While certain embodiments have been described, these embodiments have been presented by way of example only, and are not intended to limit the scope of the inventions. Indeed, the novel methods and systems described herein may be embodied in a variety of the other forms; furthermore, various omissions, substitutions and changes in the form the methods and systems described herein may be made without departing from the sprit of the inventions. The accompanying claims and their equivalents are intended to cover such forms or modifications as would fall within the scope and spirit of the inventions.

What is claimed is:

1. An inkjet recording apparatus, comprising:
a container which contains a recording medium therein;
a supply unit which supplies a treatment liquid with a first amount per unit area to a first region of the recording medium fed from the container and said supply unit which supplies the treatment liquid with a second amount different from the first amount per unit area to a second region of the recording medium;
a recording unit which supplies ink with the same amount per unit area to the first and second regions of the recording medium and said recording unit which forms an image;
a detection unit which detects states of the recording medium and the ink in the first and second regions to which the ink has been supplied; and
a control unit which controls the supply of the treatment liquid to be supped to the recording medium based on the states of the recording medium and the ink detected by the detection unit.

2. The inkjet recording apparatus according to claim 1, wherein the recording unit supplies the ink with the same area and the same amount to the first and second regions of the recording medium.

3. The inkjet recording apparatus according to claim 1, further comprising a storage unit which stores the supply of the treatment liquid, to be supplied to the recording medium, which is controlled by the control unit,
wherein in the case where the supply of the treatment liquid to be supplied to the recording medium is not stored in the storage unit, the supply unit supplies the treatment liquid to the recording medium, the recording unit supplies the ink to the recording medium, the detection unit detects the states of the recording medium and the ink, and the control unit controls the supply of the treatment liquid to be supplied to the recording medium.

4. The inkjet recording apparatus according to claim 3, further comprising an open/close detection unit which detects the opening and closing of the container,
wherein after the open/close detection unit detects the opening of the container, or after the open/close detection unit is shifted from an unworking state to a workable state, the control unit deletes a value of the supply of the treatment liquid volume, to be supplied to the recording medium, which is stored in the storage unit.

5. The inkjet recording apparatus according to claim 1, wherein the detection unit has a sensor which detects a deformation degree of the recording medium as the state of the recording medium.

6. The inkjet recording apparatus according to claim 1, wherein the detection unit has a sensor which detects, as the state of the ink supplied to the recording medium, an ink penetration degree of which ink supplied from the recording unit penetrates into the recording medium when an image is formed on the recording medium.

7. The inkjet recording apparatus according to claim 1, further comprising an input unit which receives an input from a user, wherein when the input unit receives an input of instruction to regulate the supply of the treatment liquid to be supplied to the recording medium, the supply unit supplies the treatment liquid to the recording medium, the recording unit supplies the ink to the recording medium, the detection unit detects the states of the recording medium and ink, and the control unit controls the supply of the treatment liquid to be supplied to the recording medium.

8. The inkjet recording apparatus according to claim 1, further comprising an input unit which receives an input from a user, wherein in the case where the number of times of image formation based on an image formation request received through the input unit is not less than a predetermined number, the supply unit supplies the treatment liquid to the recording medium, the recording unit supplies the ink to the recording medium, the detection unit detects the states of the recording medium and the ink, and the control unit controls the supply of the treatment liquid to be supplied to the recording medium.

9. A method of supplying a treatment liquid in an inkjet recording apparatus, comprising:
feeding a recording medium to an image formation unit;
supplying a treatment liquid with a first amount per unit area to a first region of the fed recording medium and supplying the treatment liquid with a second amount different from the first amount per unit area to a second region of the recording medium;
supplying, under the same conditions, the ink to the first and second regions to which the treatment liquid has been supplied; and
regulating the supply of the treatment liquid to be supplied to the recording medium based on the states of the recording medium and the ink in the first and second regions to which the ink has been supplied.

10. The method of supplying a treatment liquid in an inkjet recording apparatus according to claim 9, wherein when an input of instruction to regulate the supply of the treatment liquid to be supplied to the recording medium is received, the supply of the treatment liquid to be supplied to the recording medium is regulated.

11. The method of supplying a treatment liquid in an inkjet recording apparatus according to claim 10, wherein the ink with the same area and the same amount is supplied to the first and second regions of the recording medium.

12. The method of supplying a treatment liquid in an inkjet recording apparatus according to claim 10, further comprising storing the supply of the treatment liquid to be supplied to the recording medium, wherein in the case where the supply of the treatment liquid to be supplied to the recording medium is not stored, the treatment liquid is supplied to the recording medium, the ink is further supplied to the recording medium, the states of the recording medium and the ink are detected, and the supply of the treatment liquid to be supplied to the recording medium is regulated.

13. The method of supplying a treatment liquid in an inkjet recording apparatus according to claim 12, further comprising detecting opening and closing of a container which contains the recording medium therein, wherein after the opening of the container is detected, or after open/close detection is shifted from an unworking state to a workable state, the stored supply of the treatment liquid to be supplied to the recording medium is deleted.

14. The method of supplying a treatment liquid in an inkjet recording apparatus according to claim 10, wherein a deformation degree of the recording medium is detected as the state of the recording medium.

15. The method of supplying a treatment liquid in an inkjet recording apparatus according to claim 10, wherein an ink penetration degree of which ink penetrates into the recording medium is detected when an image is formed on the recording medium as the state of the ink supplied to the recording medium.

16. An inkjet recording apparatus, comprising:
a container which contains a recording medium therein;
a supply unit which supplies a treatment liquid with a first amount per unit area to a first region of the recording medium fed from the container;
a recording unit which supplies ink to the first region of the recording medium and said recording unit forms an image;
a detection unit which detects a state of the recording medium and the ink in the first region to which the ink has been supplied; and
a control unit which controls the supply of the treatment liquid to be supplied to the recording medium based on the state of the recording medium and the ink detected by the detection unit.

17. The inkjet recording apparatus according to claim 16, wherein the supply unit further supplies, to a second region, the treatment liquid with a second amount different from the first amount per unit area, the image forming unit further supplies the ink to the second region to form an image, the detection unit further detects the state of the recording medium and the ink in the second region, and the supply of the treatment liquid to be supplied to the recording medium is controlled based on changes of the states of the recording medium and the ink detected by the detection unit.

18. The inkjet recording apparatus according to claim 16, wherein the detection unit has a sensor which detects a deformation degree of the recording medium as the state of the recording medium.

19. The inkjet recording apparatus according to claim 16, wherein the detection unit has a sensor which detects, as the state of the ink supplied to the recording medium, an ink penetration degree of which ink penetrates into the recording medium when an image is formed on the recording medium.

20. The inkjet recording apparatus according to claim 16, wherein data showing a relationship between the deformation degree and the ink penetration degree is stored, and the supply of the treatment liquid is controlled with reference to the data.
